(19) United States
(12) Patent Application Publication
(10) Pub. No.: US 2026/0109153 A1
(43) Pub. Date: Apr. 23, 2026

(54) IMAGE FORMING APPARATUS

(71) Applicant: KYOCERA Document Solutions Inc., Osaka (JP)

(72) Inventor: Ryo EGAMI, Osaka (JP)

(73) Assignee: KYOCERA Document Solutions Inc., Osaka (JP)

(21) Appl. No.: 19/362,204

(22) Filed: Oct. 17, 2025

(30) Foreign Application Priority Data
Oct. 21, 2024 (JP) 2024-185378

(51) Int. Cl. B41J 2/21; B41J 3/44; B41J 13/10; G06K 15/10; H04N 1/60

(52) U.S. Cl. CPC B41J 2/2128; B41J 2/2103; B41J 2/2135; B41J 2/2142; B41J 3/44; B41J 13/106; G06K 15/102; H04N 1/6044; H04N 1/605

(57) ABSTRACT

An image forming apparatus includes a controller that causes a plurality of ink heads to eject ink to form a test chart, a density calculator that analyzes the test chart that has been read, and calculates the density of each of the images respectively formed by the plurality of ink heads, a decider that decides whether the density of the images is within a predetermined range from a density average of the images respectively formed by the ink heads of the same color, and an adjustment value calculator that calculates, with respect to the ink head that has formed the image, the density of which is deviated from the predetermined range, an adjustment value for adjusting the reference voltage to be used by the drive device driving the ink head, such that the density of the image to be formed becomes closer to the density average.

### INCORPORATION BY REFERENCE

This application claims priority to Japanese Patent Application No. 2024-185378 filed on Oct. 21, 2024, the entire contents of which are incorporated by reference herein.

### BACKGROUND

The present disclosure relates to an inkjet image forming apparatus.

Many of known inkjet image forming apparatuses include a plurality of ink heads provided for each of colors, to eject ink thereby forming an image on a recording sheet.

### SUMMARY

The disclosure proposes further improvement of the foregoing technique.

In an aspect, the disclosure provides an image forming apparatus including a plurality of head units, a plurality of drive devices, an output tray, a document reading device, and a control device. The plurality of head units are provided for each of colors for forming a color image, and each include an ink head that ejects ink thereby forming an image on a recording sheet. The plurality of drive devices each drive a corresponding one of the plurality of ink heads that eject the ink of a same color, and cause the ink head to eject the ink. The output tray receives the recording sheet on which the image has been formed by the ink heads. The document reading device reads an image of a document. The control device comprising a processor and functioning, through the processor executing a control program, as a controller, a density calculator, a decider, and an adjustment value calculator. The controller causes the plurality of ink heads, by controlling the drive device on a basis of a predetermined reference voltage, to eject the ink thereby forming a test chart composed of a predetermined pattern of images on the recording sheet, and delivers the recording sheet on which the test chart has been formed, to the output tray. The density calculator analyzes the images of the test chart, acquired by the document reading device through reading of the recording sheet on which the test chart has been formed, and calculates density of the images, respectively formed by the plurality of ink heads, with respect to each of the images. The decider decides whether the density of each of the images respectively formed by the plurality of ink heads is within a range defined by a predetermined threshold, from a density average of the images respectively formed by the plurality of ink heads of the same color. The adjustment value calculator calculates, with respect to the ink head that has formed the image, the density of which has been decided by the decider to be deviated from the range, an adjustment value for adjusting the reference voltage to be used by the drive device driving the ink head, such that the density of an image to be formed becomes closer to the density average.

### BRIEF DESCRIPTION OF THE DRAWINGS

FIG. 1 is a perspective view showing the appearance of an image forming apparatus according to an embodiment of the disclosure;

FIG. 2 is a functional block diagram schematically showing an essential internal configuration of the image forming apparatus according to the embodiment of the disclosure;

FIG. 3A is a schematic drawing showing a head unit including ink heads, viewed from below;

FIG. 3B the head unit including the ink heads, viewed from a front side;

FIG. 4 is a schematic drawing showing a part of an image forming device;

FIG. 5 is a schematic drawing showing an example of a test chart formed on a recording sheet;

FIG. 6 is a schematic drawing showing another example of the test chart formed on the recording sheet; and

FIG. 7 is a flowchart showing an exemplary density adjustment process, performed by the image forming apparatus.

### DETAILED DESCRIPTION

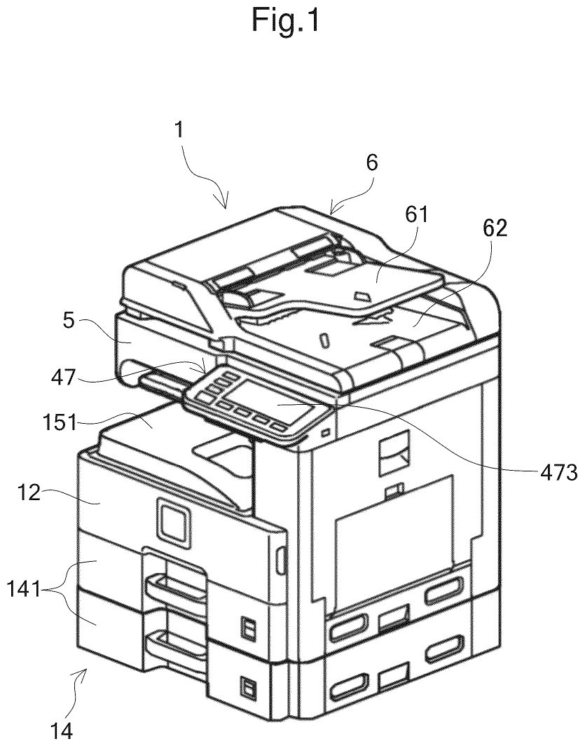

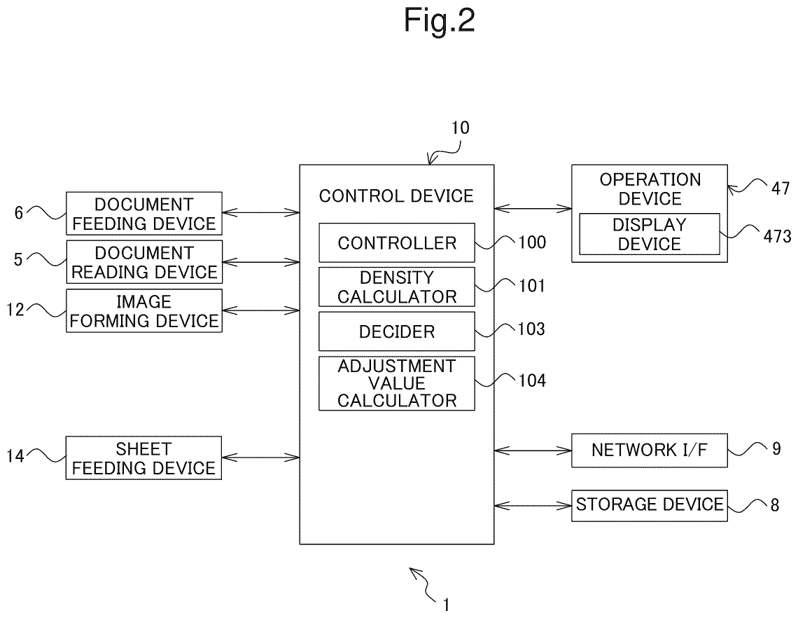

FIG. 1 is a perspective view showing the appearance of an image forming apparatus according to an embodiment of the disclosure. FIG. 2 is a functional block diagram schematically showing an essential internal configuration of the image forming apparatus according to the embodiment of the disclosure.

The image forming apparatus 1 is a multifunction peripheral having a plurality of functions, such as copying, printing, scanning, and facsimile transmission. The image forming apparatus 1 includes a control device 10, a document feeding device 6, a document reading device 5, an image forming device 12, a sheet feeding device 14, an operation device 47, a network interface (I/F) 9, and a storage device 8.

The document feeding device 6 is openably connected to the upper face of the document reading device 5, for example via a non-illustrated hinge. The document feeding device 6 serves as a document retention cover, when a document placed on a non-illustrated platen glass is to be read. The document feeding device 6, generally called an automatic document feeder (ADF), includes a document tray 61 on which the document is placed, and a document discharge tray 62 provided on the lower side of the document tray 61. The document feeding device 6 feeds the documents placed on the document tray 61 one by one to the document reading device 5, and discharges the document to the document discharge tray 62.

The document reading device 5 includes a scanner, to read the document delivered from the document feeding device 6, or the document placed on the platen glass. The document reading device 5 can also sequentially read a plurality of documents delivered from the document feeding device 6.

To perform the document reading operation, the image forming apparatus 1 operates as follows. The document reading device 5 optically reads the image on the document delivered from the document feeding device 6 to the document reading device 5, or placed on the platen glass, and generates image data. The image data generated by the document reading device 5 is stored, for example, in a non-illustrated image memory.

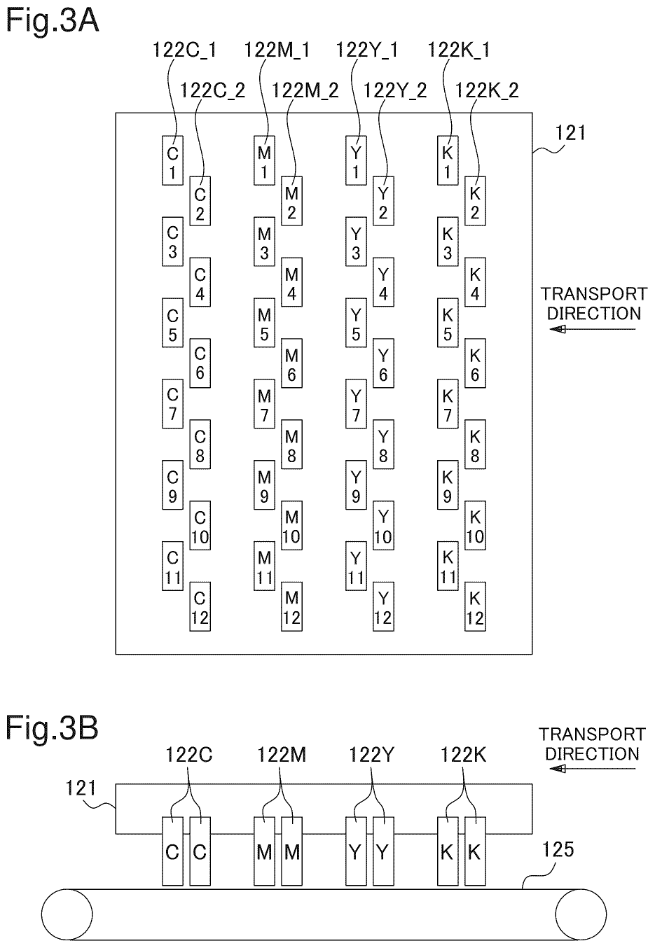

To perform the image forming operation, the image forming apparatus 1 operates as follows. The image forming device 12 includes ink heads 122 (see FIG. 3A and FIG. 3B) that each eject ink onto the recording sheet, to form an image thereon, a printing conveying device, and a drying conveying device. The image forming device 12 forms an image by ink jet printing using the ink which is the recording material, on a recording sheet, serving as a recording medium, delivered from the sheet feeding device 14, on the basis of the image data generated through the document reading operation, image data stored in the image memory, or image data received from a computer connected via the network.

The printing conveying device includes an endless conveying belt 125 (see FIG. 3B), and conveys the recording sheet placed on the conveying belt 125, and opposed to the ink heads 122. The drying conveying device also includes, like the printing conveying device, an endless conveying belt, and conveys the recording sheet having an image formed thereon and placed on the conveying belt, to naturally dry the ink stuck to the recording sheet.

As shown in FIG. 3A and FIG. 3B, the image forming device 12 includes a head unit 121 having a plurality (in this embodiment, twelve each) of ink heads 122C, 122M, 122Y, and 122K (hereinafter collectively referred to as ink head 122, where appropriate), respectively corresponding to cyan (C), magenta (M), yellow (Y), and black (K) which is the key plate. The ink head 122 is opposed to the conveying belt 125 which conveys the recording sheet. The plurality of ink heads 122C, 122M, 122Y, and 122K are aligned along the direction orthogonal to the transport direction of the recording sheet (main scanning direction), and alternately shifted from each other in the transport direction.

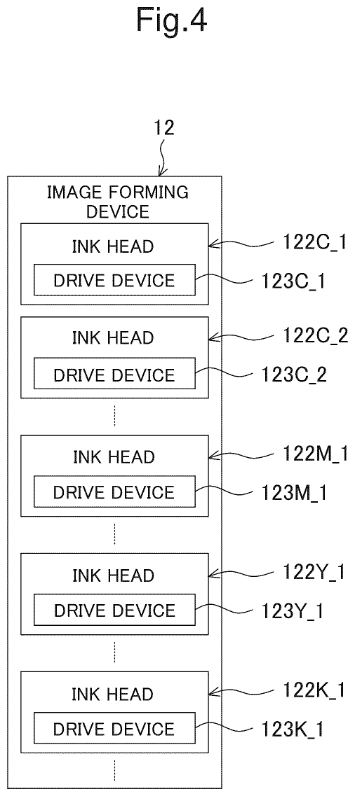

In addition, as shown in FIG. 4, the image forming device 12 includes a plurality of drive devices 123C, 123M, 123Y, and 123K (hereinafter collectively referred to as drive device 123, where appropriate), which drive the respective ink heads 122, thereby causing the ink heads 122 to eject the ink.

The sheet feeding device 14 includes a sheet cassette 141, and also includes a pickup roller, transport rollers, a transport route, and rotational drive mechanism for the rollers, to pick up the recording sheet from the sheet cassette 141 and transport the recording sheet to the image forming device 12.

The operation device 47 includes various hard keys to be operated by the user, and receives the user's instructions inputted with the hard keys, to execute the functions and operations that the image forming apparatus 1 is configured to perform, for example the image forming operation.

The operation device 47 includes a display device 473 for displaying, for example, an operation guide for the user. The operation device 47 receives, through a touch panel provided on the display device 473, the user's instruction based on the touch operation performed by the user on the screen displayed on the display device 473.

The display device 473 includes, for example, a liquid crystal display (LCD). When the user touches a button or a key displayed on the screen, the touch panel receives the instruction corresponding to the touched position. In this case, the touch panel acts as a part of the operation device.

The network I/F 9 is a communication interface that transmits and receives various types of data to and from an external device (e.g., a personal computer) located inside the local area, or on the internet.

The storage device 8 is a large-capacity storage device such as a hard disk drive (HDD) or a solid-state drive (SSD), and contains various control programs.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 10 includes as a controller 100, a density calculator 101, a decider 103, and an adjustment value calculator 104.

To be more specific, the control device 10 acts as the controller 100, the density calculator 101, the decider 103, and the adjustment value calculator 104, when the processor operates according to the control program stored in the storage device 8. Here, the controller 100 and other components may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the sheet feeding device 14, the operation device 47, the network I/F 9, and the storage device 8, and controls the operation of the mentioned components. The controller 100 also executes some processings required for the image forming operation to be performed by the image forming apparatus 1.

For example, the controller 100 controls the operation of the drive device 123, to increase or decrease a drive voltage to be applied to the drive device 123, with respect to a predetermined reference voltage RV, depending on the density indicated by the print data. In other words, the controller 100 adjusts the amount (density) of the ink ejected from the ink head 122, by varying the drive voltage applied to the drive device 123.

Further, the controller 100 controls the operation of the drive device 123 on the basis of the reference voltage RV, to cause the plurality of ink heads 122 to eject the ink, so as to form a test chart TC composed of a predetermined image pattern on the recording sheet P1, and delivers the recording sheet P1 to the output tray 151.

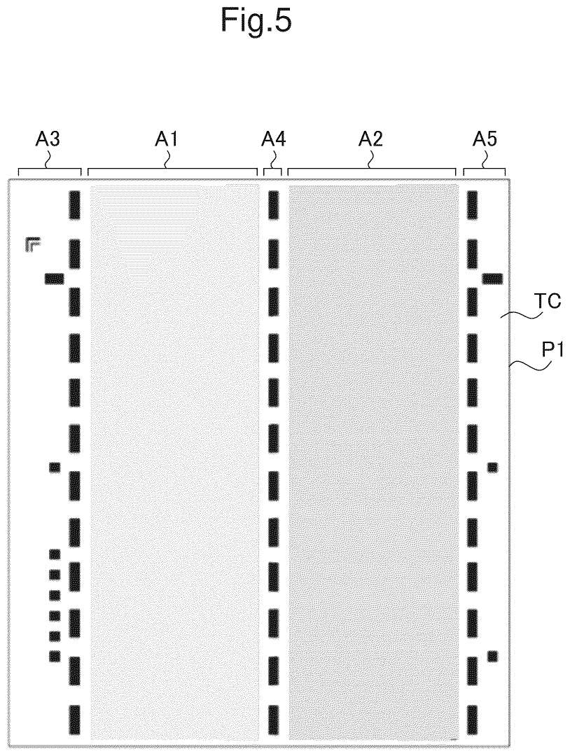

FIG. 5 is a schematic drawing showing an example of the test chart TC formed on the recording sheet P1. The test chart TC formed on the recording sheet P1 includes density calculation regions A1 and A2, to be used to calculate the density of the image formed by the ink head 122, and position detection regions A3 to A5 to be used to detect the position of the ink head that has formed the image.

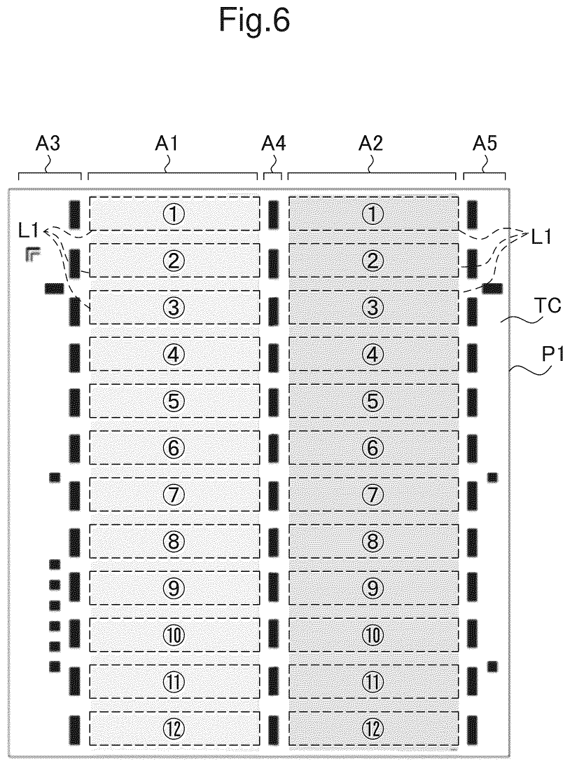

Referring to FIG. 6, the images enclosed by broken lines L1 in the density calculation region A1 each represent an image segment formed by one of the twelve ink heads 122C of the cyan color. In FIG. 6, the image segments respectively formed by the twelve ink heads 122C of the cyan color are sequentially aligned from the top, in the density calculation region A1.

The images enclosed by broken lines L1 in the density calculation region A2 each represent the image segment formed by one of the twelve ink heads 122M of the magenta color. In FIG. 6, the image segments respectively formed by the twelve ink heads 122M of the magenta color are sequentially aligned from the top, in the density calculation region A2.

The density calculator 101 analyzes the image of the test chart TC, acquired through the reading operation by the document reading device 5, and calculates the density of the image segments respectively formed by the plurality of ink heads 122, with respect to each of the image segments.

For example, the density calculator 101 detects the pixel value of each of the pixels constituting the image of the test chart TC, acquired through the reading operation by the document reading device 5, and calculates, on the basis of the detected pixel value, the total sum of the pixel value of the pixels constituting each of the image segments, respectively formed by the plurality of ink heads 122 (twelve ink heads 122 of the same color), as density DS of these image segments. Further, the density calculator 101 calculates, on the basis of the density of each of the image segments, the average of the total sum of the pixel value of all the image segments respectively formed by the plurality of ink heads 122, as a density average AV. Here, the positions of the regions, corresponding to the image segments respectively formed by the plurality of ink heads 122, with respect to the entirety of the image of the test chart TC, is stored in advance in the density calculator 101. Alternatively, the density calculator 101 may calculate the density, by counting the extent of concentration of the image.

The decider 103 decides whether the density DS of each of the image segments is within a range WR defined by a predetermined threshold TH, with respect to the density average AV.

The adjustment value calculator 104 calculates, with respect to the ink head 122 that has formed the image segment, the density of which has been decided by the decider 103 to be deviated from the range WR, an adjustment value for adjusting the reference voltage RV, to be used by the drive device 123 driving the ink head 122, such that the density DS of the image segment to be formed becomes closer to the density average AV. For example, the adjustment value calculator 104 may calculate the adjustment value, by multiplying the difference between the density DS of the image segment and the density average AV, by a predetermined adjustment coefficient for varying the reference voltage RV.

Further, the controller 100 controls the operation of the drive device 123, with respect to each of the plurality of ink heads 122, using the reference voltage RV, or using the adjustment value in the case where the reference voltage RV has been adjusted to the adjustment value, to cause the plurality of ink heads 122 to eject the ink, thereby forming the image pattern on the recording sheet as a second test chart TC2, and then delivers the recording sheet on which the second test chart TC2 has been formed, to the output tray 151.

The density calculator 101 analyzes, similarly to the case of the test chart TC, the image of the second test chart TC2, acquired through the reading operation by the document reading device 5, and calculates the density DS of the image segments respectively formed by the plurality of ink heads 122, and the density average AV.

The decider 103 decides whether the density DS of each of the image segments is within the range WR defined by the threshold TH, with respect to the density average AV of the image segments respectively formed by the ink heads 122 of the same color.

The adjustment value calculator 104 calculates, with respect to the ink head 122 that has formed the image segment, the density of which has been decided by the decider 103 to be deviated from the range WR, the adjustment value for again adjusting the reference voltage RV, to be used by the drive device 123 driving the ink head 122, such that the density DS of the image segment to be formed becomes closer to the density average AV.

Here, with respect to the ink head 122, the reference voltage RV for which has been adjusted to the adjustment value, the controller 100 sets the adjustment value as the reference voltage RV for such ink head 122.

In the case where the number of times that the reference voltage RV has been adjusted to the adjustment value reaches a predetermined upper limit (e.g., five times), and the density of any of the image segments is decided by the decider 103 to be deviated from the range WR, the controller 100 decides that the ink head 122 corresponding to such image segment is suffering an error.

On the contrary, in the case where the number of times that the reference voltage RV has been adjusted to the adjustment value is fewer than the predetermined upper limit, and the density of all the image segments is decided by the decider 103 to be within the range WR, the controller 100 controls the operation of the drive device 123 of the ink head 122, using the reference voltage RV currently effective, or the adjustment value in the case where the reference voltage RV has been adjusted to the adjustment value, for the subsequent image forming operation with the head units 121.

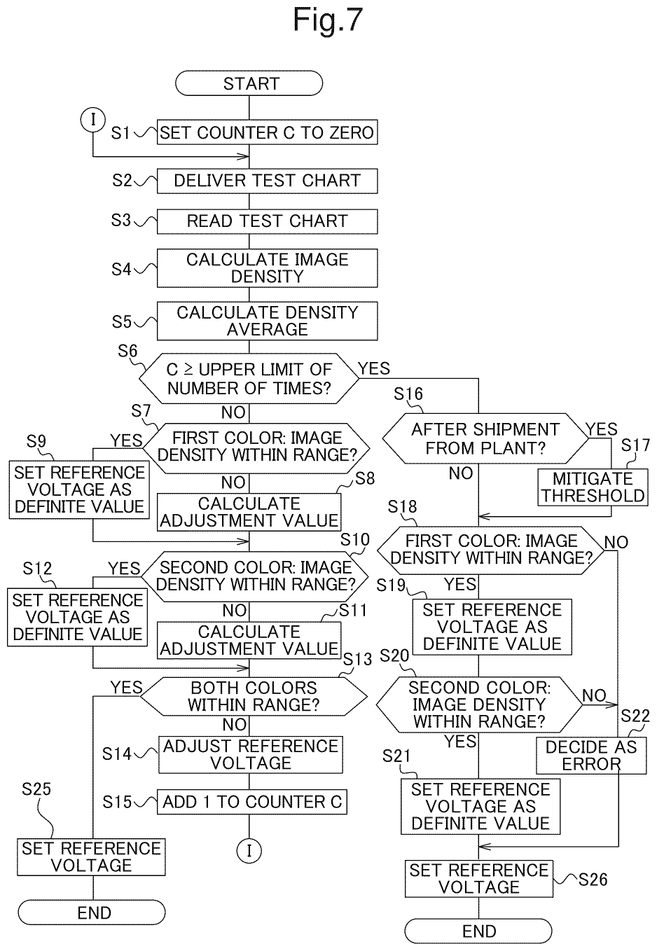

Referring now to a flowchart shown in FIG. 7, an exemplary density adjustment process, performed by the image forming apparatus 1, will be described hereunder.

The controller 100 sets a counter C, for counting the number of times of adjustment of the reference voltage RV, to zero, as initial setting (S1). The controller 100 then controls the operation of the drive devices 123, respectively corresponding to the twelve ink heads 122 provided for each of predetermined two colors (e.g., cyan and magenta), using a predetermined reference voltage RV (currently effective value), to cause the twelve each of the ink heads 122 of the two different colors to eject the ink, thereby forming the test chart TC composed of the predetermined image pattern on the recording sheet, and delivers the recording sheet to the output tray 151 (S2).

The user picks up the recording sheet having the test chart TC formed thereon, and delivered to the output tray 151, and places the recording sheet on the platen glass. When the user inputs an instruction to execute a scanning operation through the operation device 47, the controller 100 causes the document reading device 5 to read the image of the test chart TC on the recording sheet placed on the platen glass (S3). Here, the term “user” herein used refers to, for example, an inspection staff of the manufacturer, in the case where the image forming apparatus 1 is yet to be shipped from the plant, and an end user, in the case where the image forming apparatus 1 is already shipped from the plant.

After the reading operation, the density calculator 101 analyzes the image of the test chart TC, acquired through the reading operation by the document reading device 5, and calculates the density DS of the image segments, respectively formed by the twelve each of ink heads 122C of the cyan color and 122M of the magenta color, with respect to each of the image segments (S4).

The density calculator 101 then calculates a density average AV_C of all the image segments respectively formed by the twelve ink heads 122C of the cyan color, on the basis of the density DS of each of the image segments respectively formed by the twelve ink heads 122C of the cyan color, and also a density average AV_M of all the image segments respectively formed by the twelve ink heads 122M of the magenta color, on the basis of the density DS of each of the image segments respectively formed by the twelve ink heads 122M of the magenta color (S5).

After S5, the decider 103 decides whether the counter C has reached the predetermined upper limit of the number of times (S6). Upon deciding that the counter C has not reached the upper limit of the number of times (NO at S6), the decider 103 decides whether the density DS of each of the image segments, respectively formed by the twelve ink heads 122C of the cyan color (first color), is within the range WR_C defined by the predetermined threshold TH, from the density average AV_C of the cyan color (S7).

When the decider 103 decides that the density of at least one image segment is deviated from the range WR_C (NO at S7), the adjustment value calculator 104 calculates, with respect to the ink head 122C that has formed the image segment, the density of which has been decided by the decider 103 to be deviated from the range WR, an adjustment value for adjusting the reference voltage RV, to be used by the drive device 123C driving the ink head 122C, such that the density DS of the image segment to be formed becomes closer to the density average AV_C (S8). For example, when the density DS is deviated from the range WR_C to the denser side from the density average AV_C, the adjustment value calculator 104 calculates a drive voltage that reduces the ink ejected from the corresponding ink head 122C by a predetermined amount, as the adjustment value. In contrast, when the density DS is deviated from the range WR_C to the less dense side from the density average AV_C, the adjustment value calculator 104 calculates a drive voltage that increases the ink ejected from the corresponding ink head 122C by a predetermined amount, as the adjustment value.

With respect to the image segments, the density of which is within the range WR_C, the decider 103 determines the reference voltage RV currently effective for the ink heads 122C that have formed those image segments, as a definite value of the reference voltage RV (S9). In other words, the decider 103 does not calculate the adjustment value, with respect to the reference voltage RV currently effective for the ink heads 122C that have formed the image segments, the density of which is within the range WR_C.

Then the decider 103 decides, as in the case of the cyan color, whether the density DS of each of the image segments, respectively formed by the twelve ink heads 122M of the magenta color (second color), is within the range WR_M defined by the predetermined threshold TH with respect to the density average AV_M of the magenta color (S10).

When the decider 103 decides that the density of at least one image segment is deviated from the range WR_M (NO at S10), the adjustment value calculator 104 calculates, with respect to the ink head 122M that has formed the image segment, the density of which has been decided by the decider 103 to be deviated from the range WR, an adjustment value for adjusting the reference voltage RV, to be used by the drive device 123M driving the ink head 122M, such that the density DS of the image segment to be formed becomes closer to the density average AV_M (S11). The adjustment value may be calculated in a similar way to the calculation for the cyan color.

With respect to the image segments, the density of which is within the range WR_M, the decider 103 determines the reference voltage RV currently effective for the ink heads 122M that have formed those image segments, as a definite value of the reference voltage RV (S12). In other words, the decider 103 does not calculate the adjustment value, with respect to the reference voltage RV currently effective for the ink heads 122M that have formed the image segments, the density of which is within the range WR_M.

Thereafter, the controller 100 decides, on the basis of the decisions made by the decider 103 at S7 and S10, whether the density of all the image segments respectively formed by the ink heads 122 of the two colors, is within the range WR, in other words whether the adjustment value has been calculated with respect to any of the ink heads 122 (S13). Upon deciding that the density of all the image segments respectively formed by the ink heads 122 of the two colors, is within the range WR, in other words that the adjustment value has been calculated with respect to none of the ink heads 122 (YES at S13), the controller 100 sets the reference voltage RV, currently effective for the ink heads 122 of each of the two colors, as the reference voltage RV to be adopted for the subsequent image forming operation (S25).

On the other hand, upon deciding that the density of at least one of the image segments, respectively formed by the ink heads 122 of each color, is deviated from the range WR, in other words that the adjustment value has been calculated with respect to at least one of the ink heads 122 (NO at S13), the controller 100 adopts the adjustment value that has been calculated, as the reference voltage RV for the corresponding ink head 122 (S14), and adds 1 to the counter C (S15). Then the operation returns to S2.

Then the controller 100 controls the operation of the drive devices 123, respectively corresponding to the twelve ink heads 122C of the cyan color, and the twelve ink heads 122M of the magenta color, using the corresponding reference voltage RV (or adjustment value, if calculated), to cause the twelve ink heads 122C of the cyan color, and the twelve ink heads 122M of the magenta color to eject the ink, thereby forming the second test chart TC2 composed of the predetermined image pattern, on the recording sheet, and delivers the recording sheet to the output tray 151 (S2). Thereafter, the operation of S3 to S5 is performed, as described above.

Upon deciding at S6 that the counter C has reached the upper limit of the number of times (YES at S6), the decider 103 decides whether the image forming apparatus 1 is in a predetermined state after the shipment from the plant (S16). For example, the decider 103 decides whether the initial setting (e.g., setting of date and time) for the image forming apparatus 1 has been completed by the end user, on the basis of the values of the setting items related to the operation of the image forming apparatus 1, stored in a built-in memory of the control device 10, and decides that the image forming apparatus 1 is in the state after the shipment from the plant, when the values indicating that the initial setting has been completed are stored in the memory. When the values indicating that the initial setting has been completed are not stored in the memory, the decider 103 decides that the image forming apparatus 1 is in the state before the shipment from the plant.

Upon deciding that the image forming apparatus 1 is in the state after the shipment from the plant (YES at S16), the decider 103 changes the threshold TH to a predetermined mitigated threshold (S17). In contrast, upon deciding that the image forming apparatus 1 is not in the state after the shipment from the plant, but in the state before the shipment from the plant (NO at S16), the decider 103 does not change the threshold TH to the mitigated threshold. Here, the mitigated threshold may be set, for example, to a value 10% higher than the threshold TH.

The decider 103 decides whether the density DS of each of the image segments is within the range WR defined by the threshold TH, with respect to the density average AV of all the image segments respectively formed by the ink heads 122 of the same color.

To be more specific, the decider 103 decides whether the density is within the range WR_C defined by the threshold TH currently effective, from the density average AV_C, with respect to each of the image segments respectively formed by the twelve ink heads 122C of the cyan color (first color) (S18).

Upon deciding that the density of all the image segments respectively formed by the twelve ink heads 122C of the cyan color is within the range WR_C (YES at S18), the decider 103 determines the current reference voltage RV as the definite value (S19).

Then the decider 103 decides, as in the case of the cyan color, whether the density is within the range WR_M defined by the threshold TH currently effective, from the density average AV_M, with respect to each of the image segments respectively formed by the twelve ink heads 122M of the magenta color (second color) (S20).

Upon deciding that the density of all the image segments respectively formed by the twelve ink heads 122M of the magenta color is within the range WR_M (YES at S20), the decider 103 determines the current reference voltage RV as the definite value (S21).

Then the controller 100 sets the currently effective reference voltage RV of the ink heads 122 of each of the two colors, as the reference voltage RV to be used for the subsequent image forming operation (S26). Thereafter, the operation is finished.

On the other hand, when the decider 103 decides that the density of at least one of the image segments respectively formed by the twelve ink heads 122C of the cyan color is deviated from the range WR_C (NO at S18), of that the density of at least one of the image segments respectively formed by the twelve ink heads 122M of the magenta color is deviated from the range WR_M (NO at S20), the controller 100 decides that the ink head 122 is suffering an error, and displays a message to this effect on the display device 473 (S22). At this point, the controller 100 may also display, on the basis of the result from S18 and S20, a message indicating the ink head 122 of which color is suffering the error, on the display device 473. Thereafter, the operation is finished.

The same operation described above, performed with respect to the two colors, namely cyan and magenta, is also performed with respect to the twelve each of the ink heads 122 of the remaining two colors, namely yellow and black, according to the flowchart shown in FIG. 7.

According to the foregoing embodiment, the adjustment value for adjusting the reference voltage RV, to be outputted by the drive device 123 driving the ink head 122, is calculated such that the density of each of the image segments respectively formed by the plurality of ink heads 122 falls within the range WR defined by the predetermined threshold TH with respect to the density average AV. Utilizing the reference voltage RV, adjusted on the basis of such adjustment value, enables unevenness in ink ejection amount among the ink heads 122 to be suppressed, thereby preventing unevenness in density of the image, arising from the uneven ink ejection amount among the ink heads 122.

Repeating the adjustment of the reference voltage RV a certain number of times can bring the image density to a value that falls within the range WR. Accordingly, in the case where the image density fails to fall within the range WR, despite adjusting the reference voltage RV many times, it is most probable that the ink head 122 is malfunctioning.

According to the foregoing embodiment, in the case where the decider 103 still decides that the density of at least one image segment is deviated from within the range WR, despite that the number of times (value of the counter C) that the reference voltage RV has been adjusted to the adjustment value has exceeded the upper limit, the controller 100 decides that the ink head 122 is suffering an error, and notifies the user that the ink head 122 is malfunctioning.

The density of the image formed by the image forming apparatus 1 on the recording sheet varies depending on the type (characteristics) of the recording sheet to be used. Although the image forming apparatus 1 can be inspected using the recording sheet of a specific type in the plant, it is impossible to identify the type of the recording sheet after the image forming apparatus 1 is shipped from the plant, and therefore the inspection has to be performed using various types of recording sheets. In addition, while a well-furnished inspection environment (e.g., temperature and humidity) is available in the plant, it is difficult to prepare an appropriate inspection environment, after the image forming apparatus 1 is shipped from the plant. Further, performing the inspection less strictly after the shipment from the plant, compared with the inspection before the shipment from the plant, leads to shortened downtime, thereby preventing degradation in productivity.

According to the foregoing embodiment, in the case where the number of times (value of the counter C) that the reference voltage RV has been adjusted to the adjustment value has reached the upper limit, and the image forming apparatus 1 is in the state after the shipment from the plant, the decider 103 mitigates the threshold TH for the decision making. This is because, after the shipment from the plant, mitigating the threshold TH to reduce the likelihood that the error decision is made, thereby enabling the image forming apparatus 1 to continue with the operation, even with slight compromise in image quality, is more advantageous from the viewpoint of convenience to the user, rather than frequently incurring the downtime for adjusting work based on the error decision.

According to the foregoing embodiment, as described above, the adjustment of the density, by reading the outputted image can be performed as desired, irrespective of the type of the sheet used for the density adjustment of the image formed by ejection of the ink from the ink head 122. Therefore, the arrangement according to the embodiment eliminates the need to use a specific sheet for the density adjustment.

As described above, since the density of the image formed by the image forming apparatus 1 on the recording sheet varies depending on the type (characteristics) of the recording sheet to be used, it is preferable that the adjustment coefficient used to calculate the adjustment value is determined according to the characteristics of the recording sheet, on which the image segments are to be formed. In other words, it is preferable to employ a predetermined adjustment coefficient, specified according to the characteristics of the recording sheet, as the adjustment coefficient to be used to calculate the adjustment value.

The foregoing embodiment refers to the case where the controller 100 forms the test chart using the ink heads 122 of two colors. As an alternative embodiment, the controller 100 may form the test chart using the ink heads 122 of only one color, or using the ink heads 122 of three or more colors, and perform the operation specified in the flowchart of FIG. 7. In such cases, the operation of S7 to S14, and the operation of S18 to S21 are performed according to the number of colors used for forming the test chart.

In the case of the existing image forming apparatuses, not configured according to the foregoing embodiment, the ink ejection amount may vary among the ink heads, despite applying the same drive voltage to all the ink heads, because of individual difference among the ink heads. Such unevenness of the ink ejection amount may incur uneven density in the image formed on the recording sheet.

In the case of such an image forming apparatus, for example, a sample is outputted according to a predetermined target value of the density, and the adjustment is made by reading the sample, as a method for correcting the unevenness in density arising from the variation in ink ejection amount among the nozzles of the ink head. In this case, however, since the density of the image formed on the sheet may vary depending on the type of the sheet, the density adjustment by reading the outputted image may fail to be performed as desired, or a specific sheet may have to be prepared, for the intended density adjustment.

With the arrangement according to the foregoing embodiment, in contrast, the density adjustment by reading the outputted image can be performed as desired, irrespective of the differences in type of the sheet to be used for the density adjustment of the image formed by the ink ejection from the ink heads.

The disclosure may be modified in various manners, without limitation to the foregoing embodiment. Further, the configurations and processings according to the embodiment, described with reference to FIG. 1 to FIG. 7, are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is;

1. An image forming apparatus comprising:
a plurality of head units provided for each of colors for forming a color image, and each including an ink head that ejects ink, thereby forming an image on a recording sheet;
a plurality of drive devices that each drive a corresponding one of the plurality of ink heads that eject the ink of a same color, and cause the ink head to eject the ink;
an output tray that receives the recording sheet on which the image has been formed by the ink heads;
a document reading device that reads an image of a document;
a control device comprising a processor and functioning, through the processor executing a control program, as a controller that causes the plurality of ink heads, by controlling the drive device on a basis of a predetermined reference voltage, to eject the ink thereby forming a test chart composed of a predetermined pattern of images, on the recording sheet, and delivers the recording sheet on which the test chart has been formed, to the output tray;
a density calculator that analyzes the images of the test chart, acquired by the document reading device through reading of the recording sheet on which the test chart has been formed, and calculates density of the images, respectively formed by the plurality of ink heads, with respect to each of the images;
a decider that decides whether the density of each of the images respectively formed by the plurality of ink heads is within a range defined by a predetermined threshold, from a density average of the images respectively formed by the plurality of ink heads of the same color; and
an adjustment value calculator that calculates, with respect to the ink head that has formed the image, the density of which has been decided by the decider to be deviated from the predetermined range, an adjustment value for adjusting the reference voltage to be used by the drive device driving the ink head, such that the density of the image to be formed becomes closer to the density average.

2. The image forming apparatus according to claim 1,
wherein the adjustment value calculator calculates, with respect to the ink head that has formed the image, the density of which has been decided by the decider to be deviated from the predetermined range, a drive voltage that reduces an amount of the ink ejected from the ink head by a predetermined amount, as the adjustment value, when the density of the image is denser than the density average, and
calculates a drive voltage that increases the amount of the ink ejected from the ink head by a predetermined amount, as the adjustment value, when the density of the image is less dense than the density average.

3. The image forming apparatus according to claim 1,
wherein the controller causes the plurality of ink heads, by controlling the drive device on a basis of the reference voltage set to the adjustment value, to eject the ink thereby forming a second test chart composed of the pattern of images, on the recording sheet, and delivers the recording sheet on which the second test chart has been formed, to the output tray,
the density calculator analyzes image data of the second test chart, acquired through reading operation by the document reading device, and calculates density of the images, respectively formed by the plurality of ink heads, with respect to each of the images;
the decider decides whether the density of each of the images respectively formed by the plurality of ink heads is within the range defined by the predetermined threshold, from a density average of the images respectively formed by the plurality of ink heads of the same color;
the adjustment value calculator calculates, with respect to the ink head that has formed the image, the density of which has been decided by the decider to be deviated from the predetermined range, the adjustment value for again adjusting the reference voltage to be used by the drive device driving the ink head, such that the density of the image to be formed becomes closer to the density average, and
the controller decides that the ink head is suffering an error, when a number of times that the reference voltage has been adjusted to the adjustment value has reached a predetermined upper limit of the number of times, and the decider has decided that the density of at least one image is deviated from the predetermined range.

4. The image forming apparatus according to claim 1,
wherein, when a number of times that the reference voltage has been adjusted to the adjustment is fewer than a predetermined upper limit of the number of times, and the decider has decided that the density of all the images is within the predetermined range, the controller controls the drive device using the reference voltage set to the adjustment value that is currently effective, to cause the head unit to perform a subsequent image forming operation.

5. The image forming apparatus according to claim 3,
wherein, when a number of times that the reference voltage has been adjusted to the adjustment has reached a predetermined upper limit of the number of times, and the image forming apparatus is set to a state after shipment from a plant, the decider makes the decision using a predetermined mitigated threshold, less strict than the threshold.

6. The image forming apparatus according to claim 1,
wherein the ink heads are provided for each of a plurality of colors, and
the controller causes the head units of only one color, or the head units of two or more colors, to form the test chart, by controlling the drive device.

7. The image forming apparatus according to claim 1,
wherein the adjustment value calculator calculates the adjustment value, by multiplying a difference between the density of each of the images respectively formed by the plurality of ink heads, and the density average, by a predetermined adjustment coefficient for adjusting the reference voltage.

8. The image forming apparatus according to claim 7,
wherein the adjustment coefficient is determined according to characteristics of the recording sheet on which the pattern of images is to be formed.
